(19) United States
(12) Patent Application Publication
(10) Pub. No.: US 2010/0209705 A1
(43) Pub. Date: Aug. 19, 2010

(54) Moisture-Curable Compositions, and a Process for Making the Compositions

(76) Inventors: Thomas S. Lin, Whippany, NJ (US); Paul D. Whaley, Hillsborough, NJ (US); Jeffrey M. Cogen, Flemington, NJ (US); Benjamin R. Rozenblat, Belle Mead, NJ (US); Suzanne Guerra, Lake Jackson, TX (US)

Correspondence Address: WHYTE HIRSCHBOECK DUDEK S.C./DOW;Intellectual Property Department, 555 East Wells Street, Suite 1900, Milwaukee, WI, 53202, US

(21) Appl. No.: 12/679,374

(22) PCT Filed: Sep. 9, 2008
(86) PCT No.: PCT/US08/75718

§ 371 Date: Mar. 22, 2010

Related U.S. Application Data
(60) Provisional application No. 60/974,562, filed on Sep. 24, 2007.

(51) Int. Cl. C08L 51/00; C08K 3/22; C08K 3/34; C08K 3/26; B05D 3/00; B32B 1/00

(52) U.S. Cl. 428/391; 524/504; 524/430; 524/456; 524/424; 427/387

(57) ABSTRACT

Compositions useful as coatings for automobile power cables comprise a combination of raoisiure-crosslinkabk, si lane-grafted ethylene polymers in combination with a non-halogenated flame retardant. The ethylene polymers are a combination of at least one ethylene polymer with a density of 0.910 g/cc or greater and at least one ethylene polymer with a density less than 0.910 g/cc. The non-halogenated flame retardant is typically liydrated metallic filler, e.g., aluminum trihydrate. These compositions meet SAE J-1128 and DaimlerChrysler MS-8288 specifications, exhibit good shelf-life stability, and are useful in other automotive cable applications, such as ISO-6722.

### CROSS-REFERENCE TO RELATED APPLICATIONS

This application claims the benefit of U.S. Provisional Application No, 60/974,562, filed Sep. 24, 2007, which application is fully incorporated herein by reference.

### FIELD OF THE INVENTION

This invention relates to moisture-curable compositions. In one aspect, the invention relates to moisture-curable compositions comprising a polyolefin while in another aspect, the invention relates to such compositions further comprising a non-halogenated flame retardant, a silane crosslinker and a free radical initiator. In still another aspect, the invention relates to a process in which silane is grafted onto an olefin polymer in situ and in the presence of aluminum trihydrate. In yet another aspect, the invention relates to cable insulation made from the moisture-curable compositions.

### BACKGROUND OF THE INVENTION

The insulation sheath of power cables used in the automobile industry must exhibit a good balance of mechanical and flame resistant properties. With respect to the mechanical properties, these are typically provided by crosslinked polyolefins, e.g., silane-grafted polyethylene. With respect to the flame resistant property, this is typically provided by the incorporation into the polymer of a flame retarding agent. The agent can be either halogenated or non-halogenated, the latter, e.g., magnesium hydroxide, aluminum trihydrate (ATH), talc, etc., preferred.

Many examples of compositions that can be used to form the insulation sheaths of power cables exist. U.S. Pat. No. 4,549,041 describes a crosslinked, cable composition produced by mixing polyolefin resin and a metallic hydrate with a silane-grafted polyolefin resin to form a composition which is then moisture crosslinked. The composition can also contain red phosphorus and carbon black.

Another example is U.S. Pat. No. 4,921,916 which describes a process for making a halogen-free, fire-retardant, crosslinked product by first forming a halogen-free composition whose essential ingredients are at least one filler, an ethylene copolymer, a silane, a free radical grafting initiator and a silanol condensation catalyst. The free radical initiator has a half-life of less than 10 minutes at a temperature 25° C. below the decomposition temperature of the filler. The grafting temperature is at least 25° C. below the decomposition temperature of the filler. The polymers used in the examples are ethylene/ethyl acrylate (EEA), very low density polyethylene (VLDPE) and ethylene/propylene/diene monomer (EPDM).

Another example is U.S. Pat. No. 6,703,435 B2 which describes a method of producing a crosslinkable polymer composition by mixing a thermoplastic base polymer containing ATH with a carrier polymer containing silane and a peroxide to produce a slime crosslinkable compound at temperature below 165° C. The preferred peroxide uses a decomposition temperature below 165° C. One example used polyethylene and polyethylene grafted with maleic anhydride polymers.

Other examples include U.S. Pat. Nos. 4,732,939, 5,883,144 and 5,312,861, and U.S. Published Patent Applications 2003/0134969 and 2003/0114604, and EP 0 426 073, 0 365 289 and 0 245 938.

Compositions for use in automobile power cable applications must meet one or more industry standards, e.g., SAE J-1128 and/or DaimierChrysler MS 82.88. The SAE standard requires that for a cable to be used in a surface vehicle electrical system, it must be useful at nominal voltages of 60 volts direct current (or 25 volts AC) or less in normal applications with limited exposure to fluids and physical abuse. The DaimlerChrysler MS 8288 standard requires that the cable insulation demonstrate both good elongation and heat resistance at 150° C.

U.S. Pat. No. 6,326,422 describes an irradiation crosslinkable composition for SAE J-1128 and appliance wire applications. The compositions comprise ethylene copolymer, hydrated inorganic filler, an alkoxysilane and a zinc salt of mercaptobenzimidazole compound. Several patents describe peroxide crosslinkable compositions for SAE J-1128 applications, e.g., EP 0 062 187 and U.S. Pat. Nos. 5,225,468, 5,955,525 and 6,197,864. U.S. Pat. No. 5,401,787 describes a flame-retardant, moisture-curable composition for SAE J-1128 applications, the composition comprising (a) silane copolymer, (h) halogenated carboxylic acid anhydride, and (c) antimony trioxide.

### SUMMARY OF THE INVENTION

The compositions of this invention comprise a specific combination of moisture-crosslinkable polymers in combination with a non-halogenated flame retardant. These compositions meet SAE J-1128 and DaimlerChrysler MS-8288 specifications, exhibit good shelf-life stability, and are useful in other automotive cable applications, such as ISO-6722.

In a first embodiment, the invention is a composition comprising;

1. At least one first silane-grafted ethylene polymer with a density of 0.910 grams per cubic centimeter (g/cc) or greater;

2. At least one second silane-grafted ethylene polymer with a density of less than 0.910 g/cc; and

3. At least one non-halogenated flame retardant.

The silane grafted to the ethylene polymer is typically derived from a vinyl silane, and the non-halogenated flame retardant is typically a metal hydrate. The densities of the first and second silane-grafted ethylene copolymers are that of the ethylene copolymers before grafting, and the first and second silane-grafted copolymers are separate and distinct from one another, not fractions of a multi-modal copolymer. The composition can comprise additional components such as one or more of any of the following: antioxidant, light stabilizer, inert filler, compatibilizer, coupling agent, processing aid, scorch inhibitor, and halogenated flame retardant.

In a second embodiment, the invention is a process for making the composition of the first embodiment, the process comprising the step of contacting at least one (i) ethylene polymer with a density of 0.910 g/cc or greater, (ii) ethylene polymer with a density of less than 0.910 g/cc, (iii) vinyl silane, (iv) non-halogenated flame retardant, and (v) free radical initiator at a temperature of at least 180° C. and other conditions sufficient for the grafting of the vinyl silane to the polyolefin plastomer or elastomer and the ethylene copolymer. The contacting typically occurs in a melt mixer or an extruder, e.g., a Banbury mixer or a twin-screw extruder.

In a third embodiment, the invention is a process of making a coated wire, the process comprising the steps of (1) mixing the composition of the first embodiment with a masterbatch comprising a crosslinking catalyst to form a coating composition, (2) extruding or otherwise applying the coating composition to a wire to form a coated wire, and (3) subjecting the coated wire to moisture curing conditions such that the coating composition on the wire is crosslinked.

In a fourth embodiment, the invention is a wire coated with the composition of the first embodiment. In one variation of this embodiment, the composition forms an insulation sheath on the wire.

### DESCRIPTION OF THE PREFERRED EMBODIMENTS

### Definitions

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 2.00, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, density, weight and number average molecular weight, ethylene content in an ethylene/alpha-olefin copolymer, relative amounts of components in a mixture, and various temperature and other process parameter ranges.

“Cable,” “power cable” and like terms means at least one conductor, e.g., wire, optical fiber, etc., within a protective jacket or sheath. Typically, a cable is two or more wires or optical fibers bound together, typically in a common protective jacket or sheath. The individual wires or fibers inside the jacket may be bare, covered or insulated. Typical cable designs are described in SAE J-1128 and ISO 6722.

“Polymer” means a polymeric compound prepared by polymerizing monomers, whether of the same or a different type. The generic term polymer thus embraces the term homopolymer, usually employed to refer to polymers prepared from only one type of monomer, and the term interpolymer or copolymer as defined below.

“Ethylene polymer” means a polymer containing units derived from ethylene. Ethylene polymers typically comprises at least 50 mole percent (mol %) units derived from ethylene.

“Interpolymer” and “copolymer” mean a polymer prepared by the polymerization of at least two different types of monomers. These generic terms include both classical copolymers, i.e., polymers prepared from two different types of monomers, and polymers prepared from more than two different types of monomers, e.g., terpolymers, tetrapolymers, etc.

“Polyolefin” and like terms mean a polymer derived from simple olefin monomers, e.g., ethylene, propylene, 1-butene, 1-hexene, 1-octene and the like. The olefin monomers can be substituted or unsubstituted and if substituted, the substituents can vary widely. For purposes of this invention, substituted olefin monomers include VTMS, vinyl acetate, C₂₋₆ alkyl acrylates, conjugated and nonconjugated dienes, polyenes, carbon monoxide and acetylenic compounds. Many polyolefins are thermoplastic and for purposes of this invention, can include a rubber phase. Polyolefins include but are not limited to polyethylene, polypropylene, polybutene, polyisoprene and their various interpolymers; polyvinylacetate; polyacrylate and polymethacrylate; poly and the like.

“Blend,” “polymer blend” and like terms mean a blend of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art.

“silane-grafted ethylene polymer” and like terms means a silane-containing ethylene polymer prepared by a process of grafting a silane functionality onto the polymer backbone of the ethylene polymer as described, for example, in U.S. Pat. No. 3,646,155 or 6,048,935.

“Composition” and like terms means a mixture or blend of two or more components. In the context of a mix or blend of materials from which the silane-grafted polyolefins are prepared, the composition includes at least one ethylene polymer with a density of at least 0.910 g/cc, at least one ethylene polymer with a density less than 0.910 g/cc, a non-halogenated flame retardant, a vinyl silane, and a free radical initiator. In the context of a mix or blend of materials from which a cable sheath or other article of manufacture is fabricated, the composition includes all the components of the mix, e.g., the silane-grafted ethylene polymers, non-halogenated flame retardant and any other additives such as cure catalysts, lubricant, fillers, anti-oxidants, etc.

“Catalytic amount” means an amount necessary to promote the reaction of two components at a detectable level, preferably at a commercially acceptable level.

“Crosslinked” and similar terms mean that the polymer, before or after it is shaped into an article, has xylene or decalene extractables of less than or equal to 90 weight percent greater than or equal to 50 weight percent gel content).

“Cured” and like terms means that the polymer, before or after it is shaped into an article, was subjected or exposed to a treatment which induced crosslinking.

“Crosslinkable” and like terms means that the polymer, before or after shaped into an article, is not cured or crosslinked and has not been subjected or exposed to treatment that has induced substantial crosslinking although the polymer comprises additive(s) or functionality which will effectuate substantial crosslinking upon subjection or exposure to such treatment (e.g., exposure to water).

Ethylene Polymer:

The ethylene polymer, without regard to whether the term refers to the ethylene polymer with a density of 0.910 g/cc or greater (the “first ethylene polymer”) or the ethylene polymer with a density of less than 0.910 g/cc the “second ethylene polymer”), can be homogeneous or heterogeneous. The homogeneous ethylene polymers usually have a polydispersity (Mw/Mn or MWD) in the range of 1.5 to 3.5 and an essentially uniform comonomer distribution, and are characterized by a single and relatively low melting point as measured by a differential scanning calorimeter (DSC). The heterogeneous ethylene polymers usually have an MWD greater than 3.5 and lack a uniform comonomer distribution. Mw is defined as weight average molecular weight, and Mn is defined as number average molecular weight.

The polydispersity index is measured according to the following technique: The polymers are analyzed by gel permeation chromatography (GPC) on a Waters 150° C. high temperature chromatographic unit equipped with three linear mixed bed columns (Polymer Laboratories (10 micron particle size)), operating at a system temperature of 140° C. The solvent is 1,2,4-trichlorobenzene from which about 0.5% by weight solutions of the samples are prepared for injection. The flow rate is 1.0 milliliter/minute (mm/min) and the injection size is 100 microliters (μl). The molecular weight determination is deduced by using narrow molecular weight distribution polystyrene standards (from Polymer Laboratories) in conjunction with their elution volumes. The equivalent polyethylene molecular weights are determined by using appropriate Mark-Honwink coefficients for polyethylene and polystyrene (as described by Williams and Ward in journal of Polymer Science, Polymer Letters, Vol. 6, (621) 1968, incorporated herein by reference) to derive the equation:

Mpolyethylene=(a)(Mpolystyrene)^{b}

In this equation, a=0.4316 and b=1.0. Weight average molecular weight, Mw, is calculated in the usual manner according to the formula:

Mw=Σ(wᵢ)(Mᵢ)

in which wᵢ and Mi are the weight fraction and molecular weight respectively of the i^{th} fraction eluting from the GPC column. Generally the Mw of the interpolymer elastomer ranges from 10,000, preferably 20,000, more preferably 40,000, and especially 60,000 to 1,000,000, preferably 500,000, more preferably 200,000, and especially 150,000.

Low- or high-pressure processes can produce the first or second ethylene polymers. They can be produced in gas phase processes or in liquid phase processes (that is, solution or slurry processes) by conventional techniques. Low-pressure processes are typically run at pressures below 1000 pounds per square inch (“psi”) whereas high-pressure processes are typically run at pressures above 15,000 psi.

Typical catalyst systems for preparing these ethylene polymers include magnesium/titanium-based catalyst systems, vanadium-based catalyst systems, chromium-based catalyst systems, metallocene catalyst systems, constrained geometry catalyst (CGC) systems, and other transition metal catalyst systems. Many of these catalyst systems are often referred to as Ziegler-Natta catalyst systems or Phillips catalyst systems. Useful catalyst systems include catalysts using chromium or molybdenum oxides on silica-alumina supports.

Useful ethylene polymers include low density homopolymers of ethylene made by high pressure processes (HP-LDPEs), linear low density polyethylenes (LLDPEs), very low density polyethylenes (VLDPEs), ultra low density polyethylenes (ULDPEs), medium density polyethylenes (MDPEs), high density polyethylene (HDPE), metallocene copolymers, and ethylene copolymers containing units derived from acrylic acid and/or alkyl acrylate and/or methacrylate.

High-pressure processes are typically free radical initiated polymerizations and conducted in a tubular reactor or a stirred autoclave. In the tubular reactor, the pressure is within the range of 25,000 to 45,000 psi and the temperature is in the range of 200 to 350 degrees Celsius (° C.). In the stirred autoclave, the pressure is in the range of 10,000 to 30,000 psi, and the temperature is in the range of 175 to 250° C.

The VLDPE or ULDPE can be a copolymer of ethylene and one or more alpha-olefins having 3 to 12 carbon atoms and preferably 3 to 8 carbon atoms. The density of the VLDPE or ULDPE can be in the range of 0.870 to 0.915 g/cc. The melt index (MI or I₂) of the VLDPE or ULDPE can be in the range of 0.1 to 20 grams per 10 minutes (g/10 min) and is preferably in the range of 0.3 to 5 g/10 min. The portion of the VLDPE or ULDPE attributed to the comonomer(s), other than ethylene, can be in the range of 1 to 49 percent by weight (wt %) based on the weight of the copolymer and is preferably in the range of 15 to 40 wt %.

The ethylene polymers used in the practice of this invention can comprise units derived from three or more different monomers. For example, a third comonomer can be another alpha-olefin or a diene such as ethylidene norbornene, butadiene, 1,4-hexadiene or a dicyclopentadiene. Ethylene/propylene copolymers are generally referred to as EP rubbers or more simply, EPRs, and ethylene/propylene/diene terpolymers are generally referred to as EPDM. The third comonomer can be present in an amount of 1 to 15 wt % based on the weight of the copolymer, and it is preferably present in an amount of 1 to 10 wt %. Preferably, the ethylene polymer contains units derived from two or three comonomers inclusive of ethylene.

The LLDPE can include VLDPE, ULDPE, and MDPE, which are also linear, but, generally have a density in the range of 0.916 to 0.925 g/cc. It can be a copolymer of ethylene and one or more alpha-olefins having 3 to 12 carbon atoms, and preferably 3 to 8 carbon atoms. The melt index can be in the range of 1 to 20 g/10 min, preferably in the range of 3 to 8 g/10 min, as measured by ASTM D-1238 (190° C./2.16 kg).

The density of the ethylene polymers is measured according to ASTM D-792, and for the first ethylene polymer, i.e., those with a density of 0.910 g/cc or greater before grafting, these densities range from a minimum of 0.910, preferably 0.913 and more preferably 0.915, g/cc, to a typical maximum of 0.965, preferably a maximum of 0.930 and more preferably a maximum of 0.926, g/cc. For the second ethylene polymer, i.e., those with a density of less than 0.910 g/cc before grafting, the densities range from a minimum of 0.850, preferably 0.870 and more preferably 0.880, g/cc, to a typical maximum of 0.908, preferably a maximum of 0.907 and more preferably a maximum of 0.905, g/cc.

More specific examples of the ethylene polymers useful in this invention include ATTANE™, an ethylene/1-octene ULDPE, and FLEXOMER™, an ethylene/1-hexene VLDPE, both made by The Dow Chemical Company; homogeneously branched, linear ethylene/alpha-olefin copolymers (e.g. TAFMER™. by Mitsui Petrochemicals Company Limited and EXACT™ by Exxon Chemical Company); homogeneously branched, substantially linear ethylene/.alpha.-olefin polymers (e.g. AFFINITY™ plastomers and ENGAGE™ elastomers available from The Dow Chemical Company; INFUSE™, an ethylene/1-octene multi-block copolymer available from The Dow Chemical Company; DOWLEX™, an LLDPE available from The Dow Chemical Company; PRIMACOR™, an ethylene/acrylic acid copolymer available from The Dow Chemical Company; and high pressure, free radical polymerized ethylene copolymers such as ethylene/vinyl acetate (EVA) polymers (e.g., ELVAX™ polymers manufactured by E. I. Du Pont du Nemours & Co.) and ethylene ethyl acrylate (EEA) copolymers (e.g., AMPLIFY™ EEA functional polymers available from The Dow Chemical Company).

The more preferred second ethylene polymers are the homogeneously branched linear and substantially linear ethylene copolymers with a melt index of 0.01-1,000, preferably 0.01-100 and more preferably 0.01-10, g/10 min. The substantially linear ethylene copolymers are especially preferred, and are more fully described in U.S. Pat. No. 5,986,028. Typically, each of the first and second ethylene polymers is a single polymer, but a blend of two or more ethylene polymers can be used for either or both of the first and second ethylene polymers so long as the blend satisfies the density requirement for the polymer.

The minimum amount of first ethylene polymer in the composition of this invention is typically 5, and preferably 10, wt % while the maximum amount is typically 70, and preferably 30, wt %. Likewise, the minimum amount of second ethylene polymer in the composition of this invention is typically 5, and preferably 10, wt % while the maximum amount is typically 70, and preferably 30, wt %. Typically, the total polymer content of the composition, i.e., the combined weight of the first and second ethylene polymers, based on the total weight of the composition, i.e., first and second ethylene polymers, non-halogenated flame retardant, and any other additives, is in the range of 30 to 70, preferably 40 to 60 and more preferably 45 to 55, wt %. Typically, the first and second ethylene polymers are present in a weight ratio of between 1:0.5 and 1:2, preferably between 1:0.7 and 1:1.8 and more preferably between 1:1 and 1:1.5.

Vinyl Silane:

Any silane, or a mixture of such silanes, that will effectively graft to the ethylene polymer, polyolefin plastomer and/or elastomer and the ethylene copolymer can be used in the practice of this invention. Suitable silanes include those of the general formula:

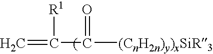

in which R′ is a hydrogen atom or methyl group; x and y are 0 or 1 with the proviso that when x is 1, y is 1; n is an integer from 1 to 12 inclusive, preferably 1 to 4; and each R″ independently is a hydrolysable organic group such as an alkoxy group having from 1 to 12 carbon atoms— (e.g, methoxy, ethoxy, butoxy), aryloxy group (e.g. phenoxy), aralkoxy group (e.g. benzyloxy), aliphatic acyloxy group having from 1 to 12 carbon atoms (e.g. formyloxy, acetyloxy, propanoyloxy), amino or substituted amino groups (alkylamine, arylamino), or a lower alkyl group having 1 to 6 carbon atoms inclusive, with the proviso that not more than two of the three R″ groups is an alkyl (e.g., vinyl dimethyl methoxy silane). Silanes useful in curing silicones which have ketoamino hydrolysable groups, such as vinyl tris(methylethylketoamino) silane, are also suitable. Useful silanes include unsaturated silanes that comprise an ethylenically unsaturated hydrocarboxyl group, such as a vinyl, ally, isopropyl, butyl, cyclohexenyl or gamma-(meth)acryloxy allyl group, and a hydrolysable group, such as, for example, a hydrocarbyloxy, hydrocarbonyloxy, or hydrocarbylamino group. Examples of hydrolysable groups include methoxy, ethoxy, formyloxy, acetoxy, proprionyloxy, and alkyl or arylamino group. Preferred silanes are the unsaturated alkoxy silanes which can be grafted onto the polymers. These silanes and their method of preparation are more fully described in U.S. Pat. No. 5,266,627. Vinyl trimethoxy silane, vinyl triethoxy silane, gamma-(meth)acryloxy propyl trimethoxy silane and mixtures of these silanes are the preferred silanes for use in establishing crosslinks.

The amount of silane used in the practice of this invention can vary widely depending upon the nature of the polymers to be grafted, the silane, the processing conditions, the grafting efficiency, the ultimate application and similar factors, but typically at least 1, preferably at least 1.5, more preferably at least 2, wt % silane, is used. Considerations of convenience and economy are usually the two principal limitations on the maximum amount of silane used in the practice of this invention, and typically the maximum amount of silane does not exceed 6, preferably it does not exceed 5, more preferably it does not exceed 4, wt %. Weight percent silane is the amount of silane by weight contained in the composition comprising (i) the polyolefin plastomer and/or elastomer, (ii) ethylene copolymer, (iii) non-halogenated flame retardant, and (iv) vinyl silane.

Non-Halogenated Flame Retardant:

The flame retardants used in the practice of this invention are hydrated inorganic fillers, e.g., hydrated aluminum oxides (aluminum trihydroxide, Al(OH)₃ or ATH), hydrated magnesia, hydrated calcium silicate, hydrated magnesium carbonates, or the like. These hydrated inorganic fillers can be used alone or in combination with one or more other hydrated inorganic fillers, and they are more fully described in U.S. Pat. No. 4,732,939. Hydrated alumina (ATH) is commonly employed as a flame retardant, and it is a preferred flame retardant for use in this invention. Water of hydration chemically bound to these inorganic fillers is released endothermically upon combustion or ignition of the plastomer or elastomer or ethylene copolymer to impart flame retardance to the composition or article made from the composition, e.g., a coated wire. Minor amounts of other types of fillers may also be present, including halogenated flame retardants although these are not preferred due to the products that they emit upon combustion. The size of the filler should be consistent with the other components of the composition, and it is typically consistent with that commonly used in the art. The flame retardant composition may contain other flame-retardant additives such as calcium carbonate, red phosphorus, silica, alumina, titanium oxide, talc, clay, organo-modified clay, zinc borate, antimony trioxide, wollastonite, mica, magadite, silicone polymers, phosphate esters, hindered amine stabilizers, ammonium octamolybdate, intumescent compounds and expandable graphite.

The minimum amount of non-halogenated flame retardant in the composition of this invention is typically 30, preferably 40, wt % while the maximum amount is typically 70, preferably 60, wt %.

Free Radical Initiator:

The vinyl silane is grafted to the plastomer, elastomer, ethylene copolymer and any other polymer(s) present in the composition at the time of grafting by any conventional method, typically in the presence of a free radical initiator, e.g., a peroxide or azo compound, or by ionizing radiation, etc. Organic initiators are preferred, such as any one of the peroxide initiators, for example, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide, and t-butyl peracetate. A suitable azo compound is azobisisobutyronitrile.

The amount of initiator can vary, but it is typically present in an amount of at least 0.04, preferably at least 0.06, wt %. Typically the initiator does not exceed 0.15, preferably it does not exceed about 0.10 wt %. The ratio of silane to initiator can also vary widely, but a typical silane:initiator ratio is 20:1 to 70:1, preferably 30:1 to 50:1.

While any conventional method can be used to graft the silane to the polymers, one preferred method is blending and melt-mixing the polymers with silane and the initiator in the first stage of a reactor extruder, such as a single screw or a twin screw extruder, preferably one with a length/diameter (L/D) ratio of 20:1 or greater. The grafting conditions can vary, but the melt temperatures are typically between 180 and 280, preferably between 190 and 250, ° C. depending upon the residence time and the half life of the initiator.

Curing or crosslinking of the silane-grafted polymers of this invention is accelerated with a cure catalyst, and any catalyst that will provide this function can be used in this invention. These catalysts generally include organic bases, carboxylic acids and organometallic compounds including organic titanates and complexes or carboxylates of lead, cobalt, iron, nickel, zinc and tin. Illustrative catalysts include dibutyl tin dilaurate, dioctyl tin maleate, dibutyl tin diacetate, dibutyl tin dioctoate, stannous acetate, stannous octoate, lead naphthenate, zinc caprylate and cobalt naphthenate. Tin carboxylates such as dibutyl tin dilaurate, dimethyl hydroxy tin oleate, dioctyl tin maleate, di-n-butyl tin maleate and titanium compounds such as titanium 2-ethylhexoxide are particularly effective for this invention.

The amount of cure catalyst, or mixture of cure catalysts, used is a catalytic amount, typically an amount between 0.01 to 0.1, preferably between 0.03 and 0.06, wt %.

Silane Grafting of the Ethylene Polymer:

The ethylene polymers are grafted with the silane in the presence of the non-halogenated flame retardant. The ethylene polymers, vinyl silane and free radical initiator are mixed using known equipment and techniques, and subjected to a grafting temperature of at least 180, preferably of at least 185, ° C. up to a temperature of 210° C. Typically the mixing equipment is either a Banbury or similar mixer, or a single or twin-screw extruder. The silane content of the silane-grafted polymers is typically between 1 and 3 wt %.

Forming the Wire Coating:

After the ethylene polymers are silane grafted, the silane-modified ethylene polymers along with the non-halogenated flame retardant are mixed with a catalyst masterbatch and extruded onto a wire. The catalyst masterbatch comprises a large amount of cure catalyst mixed with a representative portion of the silane-modified polymer/flame retardant composition to form a substantially homogeneous mixture, and this, in turn, is mixed with the bulk of the silane-modified polymers and non-halogenated flame retardant. The masterbatch can also contain other additives such as antioxidants, stabilizers, etc. The mixing usually occurs in an extruder, and the composition is then extruded onto a wire or cable followed by exposure to moisture using either a sauna or waterbath usually operated at 90° C.

The invention is described more fully through the following examples. Unless otherwise noted, all parts and percentages are by weight.

### Specific Embodiments

The following are the materials used in these examples:

(1) AFFINITY EG 8200 is a polyolefin plastomer with a density of 0.870 g/cm³ and a melt index of 5 g/10 min available from The Dow Chemical Company.

(2) AFFINITY EG 8402 is a polyolefin plastomer with a density of 0.902 g/cm³ and a melt index of 30 g/10 min available from The Dow Chemical Company.

(3) DOWLEX 2035 is a linear low density polyethylene with a density of 0.919 g/cm³ and a melt index of 6 g/10 min available from The Dow Chemical Company.

(4) AFFINITY PL 1850 is a polyolefin plastomer with a density of 0.902 g/cm³ and a melt index of 3 g/10 min. available from The Dow Chemical Company.

(5) AFFINITY KC 8852 is a polyolefin plastomer with a density of 0.885 g/cm³ and a melt index of 3 g/10 min available from The Dow Chemical Company.

(6) ATTANE 4404G is a ultra low density ethylene/octane copolymer with a density of 0.904 g/cm³ and a melt index of 4 g/10 min available from The Dow Chemical Company.

(7) SI-LINK DFDA-5451 is a silane-ethylene copolymer with 0.922 g/cm³ density and 1.5 g/10 mm melt index available from The Dow Chemical Company.

(8) SI-LINK DFDB-5480 is a catalyst masterbatch comprising a polyethylene carrier with 0.93 g/cm³ density and 3 g/10 min melt index available from The Dow Chemical Company.

(9) DFDB-5410 BK is a carbon black masterbatch with 1.15 g/cm³ density and 40 wt % carbon black in polyethylene available from The Dow Chemical Company.

(10) MARTINAL OL-104/LE is an aluminum trihydrate manufactured by Albemarle with an average particle size of 1.2-1.3 microns and a surface area of 3-5 m²/g.

(11) MARTINAL OL-104/S is a surface coated aluminum trihydrate manufactured by Albemarle with an average particle size of 1.2-2.3 microns and a surface area of 3-5 m²/g. The surface coating is silane.

(12) HYDRAL PGA-SD White is an aluminum trihydrate manufactured by ALOCA with an average particle size of 0.95 to 1.3 microns and a surface area of 4-10 m²/g.

(13) CYANOX STDP is distearyithiodipropionate available from Cytec Industry.

(14) IRGANOX 1010 or 1010 FF is tetrakis(methylene(3,5-di-tert-butyl-4-hydroxyhydrocinnamate))methane available from Ciba.

(15) INDUSTRENE 5016 is stearic acid available from Crompton Chemical,

(16) DOW CORNING Z-6518 is vinyltriethoxysilane available from Dow Corning.

(17) DOW CORNING MB50-002 is a siloxane masterbatch containing 50 wt % of high molecular weight siloxane polymer in a low density polyethylene carrier resin ultra-high molecular weight polysiloxane available from Dow Corning.

(18) TRIGONOX 29-40B PD is a peroxide masterbatch containing 40 wt % of 1,1-di(tert-butylperoxy)-3,3,5-trimethylcyclohexane on calcium carbonate and available from Akzo Nobel.

(19) TRIGONOX 101 is 2,5-dimethyl-2,5-di-(tert-butylperoxy)hexane available from Akzo Nobel

(20) VULCUP R is a mixture of the para and meta isomers of an a,a″-bis(tert-butylperoxy)-di-isopropylbenzene available from Geo Specialty Chemicals.

Tables 1-7 show comparative examples that do not meet the performance requirement as specified by SAE J-1128 and MS-8288 (in particular, elongation and high temperature test @ 150° C.). Table 1 shows the compositions of Comparative Compound. A and Comparative Compound B containing ATH and polyethylenes. These compounds are made in a Banbury mixer. After drying the compounds are blended with a silane copolymer (SI-LINK DFDA-5451) and a catalyst masterbatch (SI-LINK DFDB-5480) at a given blending ratio shown in Table 2 (Comparative Example 1 and Comparative Example II) and extruded onto a 18 AWG/19 strand copper wire using a 2.5″ Davis Standard extruder (L:D of 24:1) with a PE metering screw. The line speed is 61 m/min. The insulation thickness is 16 mils (a TXL construction according to SAE J-1128). The extruded wires are cured in a 90° C. waterbath for 12-15 hours. The wire testing results are shown in Table 2. The results show that the Comparative Example I and Comparative Example II do not meet 150° C. high temperature test according to DaimlerChrysler MS-8288 specification. The above blending approach does not provide sufficient cure to pass the high temperature test @ 150° C.

Table 3 shows the composition of Comparative Compound C containing SI-LINK DFDA-5451 copolymer, a polyolefin plastomer, and ATH. This compound is made in a Banbury mixer. After drying, this compound is then blended with a catalyst masterbatch (DFDB-5480) at the ratio shown in Table 4 (Comparative Example III) and extruded onto a 18 AWG/19 strand copper wire using a 2.5″ Davis Standard extruder (L:D of 24:1) with a PE metering screw. The line speed was 91 m/min. The insulation thickness is 16 mils. The extruded wires are cured in a 90° C., waterbath for 12-15 hours. The wire testing results are shown in Table 4. The results show that the Comparative Example III passes the 150° C. high temperature test but fails the elongation requirement. This composition improves the cure state of the finished compound relative to Comparative Examples I and II but does not provide sufficient elongation due to poor filler acceptance of SI-LINK DFDA-5451.

Table 5 shows the composition of Comparative Compound D comprising an ethylene-octene copolymer, ATH vinyltriethoxysilane, and peroxide. The components are mixed in a Banbury mixer at 180° C. to complete the silane grafting reaction. This compound is then blended with a catalyst masterbatch at the ratio reported in Table 6 (Comparative Example IV) and is extruded onto a 18 AWG/19 strand copper wire using a 2.5″ Davis Standard extruder (L:D of 24:1) with a PE metering screw. The line speed was 91 m/min. The insulation thickness is 16 mils. The extruded wires are cured in a 90° C. waterbath for 12-15 hours. The wire testing results are shown in Table 6. The results show that the Comparative Example IV passes the 150° C. high temperature test but fails the elongation requirement. This silane grafting approach using ATTANE 4404G improves filler acceptance and elongation over Comparative Example III but is still insufficient to meet the elongation requirement of SAE J-1128 and DaimlerChrysler MS-8288.

Table 7 shows the composition of Comparative Compound E comprising one linear low density polyethylene (DOWLEX 2035), one polyolefin plastomer (AFFINITY PL 1850), peroxide, vinyltriethoxysilane, and ATH. The components are mixed in a Banbury mixer at 180° C. to complete the silane grafting reaction. This masterbatch is then blended with a catalyst masterbatch (DFDB-5480) at the ratio reported in Table 8 and is extruded onto a 18 AWG/19 strand copper wire using a 2.5″ Davis Standard extruder (L:D of 24:1) with a PE metering screw. The line speed was 52 m/min. The insulation thickness is 16 mils. The extruded wires are cured in a 90° C. waterbath for 12-15 hours. The wire testing results are shown in Table 8. The results show that the Comparative Example V meets the 150° C. high temperature test but fails the elongation requirement. This example shows improved elongation over Comparative Example IV.

Table 9 shows the compositions of Compound A1 and Compound B1 comprising two Dow polyolefin plastomers (AFFINITY PL 1850 and AFFINITY KC 8852), one linear low density polyethylene (DOWLEX 2035), ATH, vinyltriethoxysilane, and peroxide. The components are mixed in a Banbury mixer at 180° C. to complete silane grafting reaction. After drying, these compounds are then blended with a catalyst masterbatch (DFDB-5480) at the ratio reported in Table 10 and are extruded onto a 18 AWG/19 strand copper wire using a 2.5″ Davis Standard extruder (L:D of 24:1) with a PE metering screw. The line speed was 69 m/min. The insulation thickness is 16 mils. The extruded wires are cured in a 90° C. waterbath for 12-15 hours. The wire testing results are shown in Table 10. The results show that surprisingly Example AA1 and Example BB1 meet the 150° C. high temperature tests and also meet the elongation requirement. A shelf-life stability study is conducted on Compound A1. Surprisingly it exhibits very good shelf-life stability with less than 10% change in Flow Index after 7 weeks of storage in a sealed foil bag at 60° C.

TABLE 1
Compositions of Masterbatches Containing ATH and Polyethylene

| | Comparative | |
|---|---|---|
| | Compound A | Comparative Compound |
| Components | Composition, wt % | B Composition, wt % |
| Affinity EG 8200 | 27.2 | 0.0 |
| Affinity EG 8402 | 0.0 | 27.2 |
| Hydral PGA-SD White | 70.0 | 70.0 |
| Cyanox STDP | 1.6 | 1.6 |
| Iraganox 1010 | 0.8 | 0.8 |
| Industrene 5016 | 0.4 | 0.4 |
| Total | 100.0 | 100.0 |

TABLE 2
Testing Results for Cured Wires Made with Masterbatches
Shown in Table 1

| | Comparative | Comparative | Minimum |
|---|---|---|---|
| | Example I | Example II | Requirement |
| | Composition, | Composition, | of J-1128 |
| | wt % | wt % | and MS-8288 |
| Component | | | |
| Compound A | 71.1 | | |
| Compound B | | 71.1 | |
| Si-Link DFDA-5451 | 27.2 | 27.2 | |
| Si-Link DFDB-5480 | 1.7 | 1.7 | |
| Total | 100.0 | 100.0 | |
| Wire Testing | | | |
| Tensile Strength, MPa | 12.5 | 13.0 | 10.3 |
| Tensile Elongation, % | 406 | 60 | 150 |
| Pinch Resistance, kg | 3.3 | 4.3 | 3.2 |
| High Temperature Test | Fail | Fail | Pass |
| @ 150° C. (MS-8288) | | | |

TABLE 3
Composition of Masterbatch Containing Si-Link DFDA-5451,
Polyethlene, and ATH

| | Comparative Compound C |
|---|---|
| Component | Composition, wt % |
| Affinity EG-8200 | 3.50 |
| Si-Link DFDA-5451 | 41.40 |
| Martinal OL-104/S | 51.0 |
| Affinity EG-8200 with 0.8 wt % Vulcup R | 2.5 |
| Cyanox STDP | 1.1 |
| IRGANOX 1010 FF | 0.5 |
| Total | 100.00 |

TABLE 4
Testing Results for Cured Wires Made with Compound C
Shown in Table 3

| | | Minimum |
|---|---|---|
| | Comparative Example | Requirement of J- |
| | III Composition, wt % | 1128 and MS-8288 |
| Component | | |
| Compound C | 95 | |
| Si-Link DFDA-5480 | 3 | |
| DFDB-5410 BK | 2 | |
| Total | 100 | |
| Wire Testing | | |
| Tensile Strength, MPa | 17.2 | 10.3 |
| Tensile Elongation, % | 67 | 150 |
| Pinch Resistance, kg | 4.3 | 3.2 |
| High Temperature Test @ | Pass | Pass |
| 150° C. | | |

TABLE 5
Composition of a masterbatch containing silane-grafted
copolymer and ATH

| | Comparative Compound D |
|---|---|
| Component | Composition, wt % |
| Attane 4404G | 40.35 |
| Martinal OL-104/LE | 53 |
| Triganox 29-40B pd | 0.15 |
| Dow Corning MB50-002 | 1.5 |
| Dow Corning Z-6518 | 3.5 |
| Cyanox STDP | 1 |
| IRGANOX 1010 FF | 0.5 |
| | 100.00 |

TABLE 6
Testing Result of Cured Wire Made with Compound D
Shown in Table 5

| | Comparative | Minimum |
|---|---|---|
| | Example IV | Requirement of |
| | Composition, wt % | J-1128 and MS-8288 |
| Component | | |
| Compound D | 95 | |
| Si-Link DFDA-5480 | 3 | |
| DFDB-5410 BK | 2 | |
| Total | 100 | |
| Wire Testing | | |
| Tensile Strength, MPa | 18.9 | 10.3 |
| Tensile Elongation, % | 77 | 150 |
| Pinch Resistance, kg | 3.4 | 3.2 |
| High Temperature | Pass | Pass |
| Test @ 150° C. | | |

TABLE 7
Composition of a Masterbatch Containing Silane-Grafted
Copolymers and ATH

| | Comparative Compound E |
|---|---|
| Component | Composition, wt % |
| Dowlex 2035 | 20.41 |
| Affinity PL 1850 | 20.41 |
| Martinal OL-104/LE | 53.00 |
| Trigonox 29-40B pd | 0.18 |
| Dow Corning MB50-002 | 1.50 |
| Dow Corning Z-6518 | 3.00 |
| Cyanox STDP | 1.00 |
| IRGANOX 1010 FF | 0.50 |
| | 100.00 |

TABLE 8
Testing Result of Cured Wire Made with Compound E
Shown in Table 7

| | Comparative | Minimum |
|---|---|---|
| | Example V | Requirement of J- |
| | Composition, wt % | 1128 and MS-8288 |
| Component | | |
| Compound E | 95 | |
| Si-Link DFDA-5480 | 3 | |
| DFDB-5410 BK | 2 | |
| Total | 100 | |
| Wire Testing | | |
| Tensile Strength, MPa | 20 | 10.3 |
| Tensile Elongation, % | 106 | 150 |
| Pinch Resistance, kg | 5.3 | 3.2 |
| High Temperature Test @ | Pass | Pass |
| 150° C. | | |

TABLE 9
Compositions of Masterbatch Containing Silane-Grafted
Copolymer and ATH

| | Compound A1 | Compound B1 |
|---|---|---|
| Component | Composition, wt % | Composition, wt % |
| Dowlex 2035 | 15.93 | 20.74 |
| Affinity PL 1850 | 15.81 | 6.00 |
| Affinity KC 8852 | 10.00 | 15.00 |
| Martinal OL-104/LE | 53.00 | 53.00 |
| Trigonox 101 | 0.06 | 0.06 |
| Dow Corning MB50-002 | 2.00 | 2.00 |
| Dow Corning Z-6518 | 2.00 | 2.00 |
| Cyanox STDP | 0.80 | 0.80 |
| IRGANOX 1010 FF | 0.40 | 0.40 |
| | 100.00 | 100.00 |

TABLE 10
Testing Results of Cured Wire Made with Compound F and G
Shown in Table 9

| | | | Minimum |
|---|---|---|---|
| | Example AA1 | Example BB1 | Requirement of |
| | Composition, | Composition, | J-1128 |
| | wt % | wt % | and MS-8288 |
| Component | | | |
| Compound F | 95 | 0 | |
| Compound G | 0 | 95 | |
| Si-Link DFDA-5480 | 3 | 3 | |
| DFDB-5410 BK | 2 | 2 | |
| Total | 100 | 100 | |
| Wire Testing | | | |
| Tensile Strength, MPa | 19.8 | 21.8 | 10.3 |
| Tensile Elongation, % | 168 | 172 | 150 |
| Pinch Resistance, kg | 4.1 | 3.8 | 3.2 |
| High Temperature | Pass | Pass | Pass |
| Test @ 150° C. | | | |

Although the invention has been described in certain detail through the preceding specific embodiments, this detail is for the primary purpose of illustration. Many variations and modifications can be made by one skilled in the art, without departing from the spirit and scope of the invention, as described in the following claims. All publications cited above, specifically including United States patents, patent application publications and allowed patent applications, are incorporated in their entirety herein by reference.

1. A composition comprising:
A. At least one first silane-grafted ethylene polymer with a density of 0.910 g/cc or greater;
B. At least one second silane-grafted ethylene polymer with a density of less than 0.910 g/cc; and
C. At least one hydrated, inorganic, non-halogenated flame retardant.

2. The composition of claim 1 comprising at least two second silane-grafted ethylene polymers.

3. The composition of claim 1 comprising 5-70 wt % of the second silane-grafted ethylene polymer.

4. The composition of claim 1 comprising 5-70 wt % of the first silane-graft ethylene polymer.

5. The composition of claim 3 comprising 5-70 wt % of the first silane-graft ethylene polymer.

6. The composition of claim 1 comprising 30-70 wt % of a non-halogenated flame retardant.

7. The composition of claim 5 comprising 30-70 wt % of a non-halogenated flame retardant.

8. The composition of claim 1 in which the first and second ethylene polymers each comprises units derived from ethylene and an alpha-olefin of 3 to 12 carbon atoms.

9. (canceled)

10. The composition of claim 1 in which the ethylene units comprise 50 wt % or more of each of the first and second ethylene polymers.

11-13. (canceled)

14. The composition of claim 1 in which the non-halogenated flame retardant comprises at least one of hydrated aluminum oxide, hydrated magnesia, hydrated calcium silicate, and a hydrated magnesium carbonate.

15. (canceled)

16. The composition of claim 1 comprising 40-60 wt % of the non-halogenated flame retardant.

17. (canceled)

18. The composition of claim 1 comprising two or more non-halogenated flame retardants.

19. (canceled)

20. The composition of claim 1 in which the first and second ethylene polymers are present in a weight ratio between 1:0.5 and 1:2.

21. A process for making the composition of claim 1, the process comprising the step of contacting (i) ethylene polymer with a density of 0.910 g/cc or greater, (ii) ethylene polymer with a density less than 0.910 g/cc, (iii) vinyl silane, (iv) non-halogenated flame retardant, and (v) free radical initiator at a temperature of at least 180° C.

22. The process of claim 21 in which the vinyl silane is of the general formula: 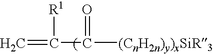
in which R′ is a hydrogen atom or methyl group; x and y are 0 or 1 with the proviso that when x is 1, y is 1; n is an integer from 1 to 12 inclusive, preferably 1 to 4; and each R″ independently is a hydrolysable organic group such as an alkoxy group having from 1 to 12 carbon atoms— (e.g. methoxy, ethoxy, butoxy), aryloxy group (e.g. phenoxy), aralkoxy group (e.g. benzyloxy), aliphatic acyloxy group having from 1 to 12 carbon atoms (e.g. formyloxy, acetyloxy, propanoyloxy), amino or substituted amino groups (alkylamine, arylamino), or a lower alkyl group having 1 to 6 carbon atoms inclusive, with the proviso that not more than two of the three R″ groups is an alkyl (e.g., vinyl dimethyl methoxy silane).

23. A process of making a coated wire, the process comprising the steps of (1) mixing the composition of claim 1 with a masterbatch comprising the composition of claim 1 and a crosslinking catalyst to form a coating composition, (2) applying the coating composition to a wire to form a coated wire, and (3) subjecting the coated wire to moisture curing conditions such that the coating composition on the wire is crosslinked.

24. A wire coated with the composition of claim 1.

25. The wire of claim 24 in which the coating is in the form of an insulation sheath.

26. The composition of claim 1 in which at least one of the first and second silane-grafted ethylene polymers is a homogeneously branched linear or substantially linear ethylene polymer.

27. (canceled)

28. The composition of claim 1 in which the second silane-grafted ethylene polymer is a homogeneously branched linear or substantially linear ethylene polymer.

29. (canceled)
